(19) United States
(12) Patent Application Publication
(10) Pub. No.: US 2010/0128473 A1
(43) Pub. Date: May 27, 2010

(54) Adjustable LED Light Fixture

(76) Inventor: Roland Parra, Los Angeles, CA (US)

Correspondence Address: MARC E. HANKIN, ESQ., 11414 THURSTON CIRCLE, LOS ANGELES, CA, 90049, US

(21) Appl. No.: 12/275,799

(22) Filed: Nov. 21, 2008

(51) Int. Cl. F21V 1/08

(52) U.S. Cl. 362/235

(57) ABSTRACT

Various embodiments of this invention disclose a quiet LED light fixture that adjusts between a neutral, flood and spot array configuration.

### FIELD OF INVENTION

This invention relates generally to light fixtures. More specifically, this invention relates to light-emitting diode (“LED”) light fixtures that can adjust between a flood array and a spot array.

### BACKGROUND

High powered lights are required on movie sets, where shoots last into the early morning hours and can feature less than ideal natural lighting. Additionally, lights that alternate between a flood and spot array are particularly useful for lighting faces and other scenes. A high-powered, adjustable, quiet light is essential on film sets. As referenced below, the prior patents do not adequately address such a product.

U.S. Pat. No. 7,163,302, issued to Pohlert et al., discloses a LED light fixture with a master power switch, designated group selector switches, a dimming lever, a rectangular frame shape, and the ability to alter the direction of the light. However, Pohlert fails to teach a light fixture with fans, ventilation apertures, a turbo switch, or a remote control. Moreover, although Pohlert discloses a means for altering the direction of the light given off by the LEDs, the reference specifically teaches that this means is a lens that is mounted in front of the LEDs. In other words, Pohlert specifically teaches a refraction means for altering the light. This is very different from the present invention, which teaches a mechanical means to actually swivel the LED clusters.

U.S. Pat. No. 6,676,279, issued to Hubbell et al., discloses a LED light fixture with multiple clusters of a plurality of high powered LEDs mounted on heat sinks, and a light fixture. However, Hubbell is directed to a street light fixture and not a film, studio, or still photography light fixture. Additionally, it does not disclose that the LED clusters can swivel or any of the other features of the present light fixture.

U.S. Pat. No. 6,106,125, issued to Finn et al., discloses a light box with four swivel lights mounted in a rectangular grid pattern. However, Finn is not specifically directed to LED lights and does not disclose a means to swivel all of the lights simultaneously through one control knob.

U.S. Pat. No. 7,144,135, issued to Martin et al., discloses a LED light fixture with a heat sink, ventilation apertures, and a fan to aid in cooling. However, Martin discloses that the light fixture uses a single LED in place of a regular light bulb in a standard home furnishing light fixture. Further, Martin fails to disclose a means to allow the LED light to swivel.

In sum, these references fail to disclose every element or limitation of the present invention. The previous conceptual designs of the prior art provide only limited utility and fail entirely to address the need for a quiet, adjustable swivel lighting device on movie sets. The present invention seeks to remedy the problems of the prior art by combining low-noise fans, LED lights, and a swivel mechanism.

### SUMMARY OF THE INVENTION

To minimize the limitations in the prior art, and to minimize other limitations that will become apparent upon reading and understanding the present specification, the present invention discloses a LED light fixture with an adjustable control knob, light-controlling flaps and LEDs mounted on heat sinks.

The present invention is unique in that: it uses LED lights that are mounted on heat sinks and can adjust between a spot, neutral, or flood array. The problems with the prior art are overcome by the present invention in that the present invention has ultra-quiet fans, sound-absorbing material, and a ventilation system, which allow it to be used on a film or television set or in the medical industry. It can adjust between light arrays in a manner that also allows for altering the temperature of the light. Some of the other unique features of the lighting fixture are remote capability, expandable cases, an internal power supply, multiple ways to diffuse light, flaps to control light output and an expanding bale. Other inventive features are disclosed below.

The invention is a light fixture comprising LED lights, an expandable light box, and adjustable light controlling flaps. Specifically, the light fixture has multiple clusters of plurality of high powered LEDs. Preferably, each cluster has LEDs in a honeycomb configuration and these LEDs are mounted on a heat sink. The light fixture itself is preferably rectangular, and in its best mode, has 25 clusters that are arrayed in a five by five manner. Importantly, in this best mode, the 24 non-middle clusters are on a swivel mount, with one non-swivel cluster. This allows them to be adjusted via a radial arm along a linear axis.

A centrally located control knob allows a user to swivel all of the non-middle clusters of the swivel mounted lights at the same time. The control knob specifically allows the user to adjust the clusters from a flood array configuration to a spot array configuration. To allow better airflow and heat dissipation, the LED clusters are positioned on a framing surface that has ventilation apertures. The light fixture also has low-volume, ultra-quiet fans to help dissipate the heat. Additionally, the interior of the light fixture is preferably lined with sound absorbing material to help quite the fans even more.

The light fixture may have other features, such as multiple power switches that allow a user to power three distinct designated groups of clusters, either alone or together, and a master power switch. The light fixture may also have a remote-controlled dimmer and a turbo switch that can be used to provide a temporary increase in brightness. All of these controls and switches are flush mounted on the back of the light fixture to allow safe portability.

An object of the present invention is to provide a LED light fixture that will overcome the deficiencies of the prior art.

Other features and advantages inherent in the LED light fixture claimed and disclosed will become apparent to those skilled in the art from the following detailed description and its accompanying drawings.

### BRIEF DESCRIPTION OF THE DRAWINGS

FIG. 1 is a perspective view of one embodiment of the LED fixture with the cases expanded, the flaps open and extended, and the curtains unfolded.

FIG. 2 is a perspective view of one embodiment of the LED fixture with the cases expanded, the flaps open and extended, and the curtains folded.

FIG. 3 is a front view of one embodiment of the LED fixture's LED configuration, with the flaps open and extended, and the curtains unfolded.

FIG. 4 is a front view of one embodiment of the LED fixture's LED configuration, with the flaps open and retracted, and the curtains folded.

FIG. 5 is a rear view of one embodiment of the LED fixture, showing the bale, all the controls, the hook and eye tabs, and the exhaust vent.

FIG. 6 is a right side view of one embodiment of the cases in a retracted position, without flaps, without the diffusion door and with the flap-retaining bracket.

FIG. 7 is a right side view of one embodiment of the cases in an expanded position, without flaps mounted, with the diffusion door and with the power cord storage door and the flap-retaining bracket.

FIG. 8 is a right side view of one embodiment of the cases in an extended position, with the flaps mounted and folded.

FIG. 9 is a right side view of one embodiment of the cases in a retracted position, with the flaps mounted and folded.

FIG. 10 is a close-up front view of one embodiment of the LEDs mounted on the heat sink.

FIG. 11 is a right side view of one embodiment of the inner case of the ventilation system.

FIG. 12 is a right side view of one embodiment of the ventilation system, with arrows that show ventilation flow within the fixture.

FIG. 13 is a back view of one embodiment of the ventilation system's fan configuration, power cord storage area, and power cord storage door, with arrows that show the direction of circulation.

FIG. 14 is a bottom view of one embodiment of the ventilation system.

FIG. 15 is a front view of one embodiment of the inner case with the radial arms, radial fingers, and brackets.

FIG. 16 is a front view of one embodiment of the inner case, with the control mechanism mounting plate attached.

FIG. 17 is a front view of one embodiment of the inner case, with the control mechanism mounted on the mounting plate.

FIG. 18 is a magnified, right side cross section view of one embodiment of the inner case.

FIG. 19 is a front view of one embodiment of the radial arms, radial fingers and brackets.

FIG. 20 is a close-up view of one embodiment of the radial arms and fingers.

FIG. 21 is a further close-up view of one embodiment of the radial arms and fingers.

FIG. 22 is a top view of one embodiment of the heat sink with LEDs attached.

FIG. 23 is a side view of one embodiment of the heat sink.

FIG. 24 is a side view of one embodiment of the heat sink, shown tilted.

FIG. 25 is a front view of one embodiment of the inner case that shows all of the LED electrical circuits.

FIG. 26 is a front view of one embodiment of the inner case that shows the first circuit.

FIG. 27 is a front view of one embodiment of the inner case that shows the second circuit.

FIG. 28 is a front view of one embodiment of the inner case that shows the third circuit.

FIG. 29 is a front view of one embodiment of the remote control box.

FIG. 30 is a top view of one embodiment of the case in an expanded position, with open and retracted flaps and folded curtains.

FIG. 31 is a top view of one embodiment of the case in an expanded position, with open and extended flaps and folded curtains.

FIG. 32 is an exploded view of one embodiment of the flap assembly.

FIG. 33 is an exploded view of one embodiment of the inner case.

FIG. 34 is an exploded view of one embodiment of the radial arms and their assembly.

FIG. 35 is an exploded view of one embodiment of the heat sinks, fans and their assembly.

FIG. 36 is an exploded view of one embodiment of the outer case.

FIG. 37 is an exploded view of one embodiment of the flaps.

### DRAWINGS—REFERENCE NUMERALS

1 9th LED Circuit Switch

2 Air Intake

3 All Three Circuits

4 Bale

5 Bale Extensions

6 Bale Hand Wheel

7 Bale Mount Hole

8 Bale Pin

9 Bearing

10 Bottom Flap Assembly

11 Bottom View

12 Center Support

13 Center Support Brace

14 Circuit 1

15 Circuit 2

16 Circuit 3

17 Circuit Switch

18 Clear Plastic Cover

19 Connecting Rod Hole

20 Connecting Rod to Heat Sink

21 Connecting Rod to Radial Arm

22 Connecting Rod

23 Control Fingers

24 Control Knob

25 Control Knob Position Indicator

26 Control Knob Shaft

27 Control Knob Shaft Hole

28 Control Mechanism Mounting Plate

29 Cooling Fans

30 Corner Connector

31 Cover Plate

32 Cover Plate Holes

33 Curtain

34 Curtain Seem

35 Curtains Extended

36 Diffusion Door

37 Diffusion Holder

38 Diffusion Holder Bottom Rail

39 Diffusion Holder Pull Tab

40 Diffusion Holder Top Piece

41 Dimmer

42 End Brace

43 End Rod Inner

44 End Rod Outer

45 End Rod Restraint

46 End Rod

47 End Rods Bracket

48 Exhaust Vent

49 Extending Rods

50 Fan Mounting Plate

51 Fan Mounting Plate Holes

52 Fan Outlet

53 Female Hook and Eye Strip

54 Finger and Arm Connection

55 Flap Cover

56 Flap Mount Bracket Attachments

57 Flap Retaining Bracket

58 Flap Retaining Bracket Assembly

59 Flaps Extended

60 Flaps Open curtains Folded

61 Flaps Open Curtains Unfolded

62 Flaps Retracted

63 Friction Hinge

64 Front Cover

65 Front View

66 Fuse

67 Heat Sink

68 Heat Sink Compression Screw

69 Heat Sink Fin

70 Heat Sink Mount

71 Heat Sink Mounting Board

72 Heat Sinks with LEDs

73 Hinge

74 Indicator Light(s)

75 Inner Case

76 Inner Case—Expanded

77 Inner Case—Retracted

78 Inner Extending Rod

79 Latch Assembly

80 Latch Catch

81 Latch Hook

82 Latch Mount

83 Latch Mounting Holes

84 Latch Notches

85 LED

86 LED Mounting Screw

87 Left Flap Assembly

88 Line Conditioner

89 Lower Curtain

90 Lower Flap

91 Male Hook and Eye Tab

92 Master Switch

93 Noise Baffle

94 Nut

95 Outer Case

96 Outer Case Expanding Slot

97 Outer Extending Rod

98 Pivot Point

99 Power Cord

100 Power Cord Storage Box

101 Power Cord Storage Door

102 Power Cord Storage Door Opening

103 Power Cord Storage Door Hook and Eye—Female

104 Power Cord Storage Door Hook and Eye—Male

105 Power Input 120 Volts AC

106 Power Supply

107 Pull Tab

108 Radial Arm and Finger Connection

109 Radial Arm to Connecting Rod

110 Radial Arm

111 Radial Finger

112 Rear View

113 Recessed Knob Area

114 Recessed Switch Panels

115 Remote Control Box

116 Remote Control Cable

117 Return Spring

118 Rivet

119 Rod Pinch Bracket

120 Rod Restraint

121 Rod Separator

122 Rods Extended

123 Screw

124 Shaft Finger and Arm Connection

125 Side View Cases Expanded

126 Side View Cases Retracted

127 Spacer

128 Spacer/Mounting Foot

129 String

130 String Extended

131 String Retainer

132 Switch and Dimmer Remote Control Plug

133 Switch and Dimmer Remote Control Socket

134 Switch Mounting Holes

135 Switch

136 Fluoropolymer Bracket

137 Top Flap Assembly

138 Upper Curtain

139 Upper Flap

140 Ventilation Flow

141 Ventilation Holes

142 Ventilation Partition

143 Washer

144 Wiring Loom

145 Flaps Closed

146 LED Tilted

147 Connecting Wires

### DETAILED DESCRIPTION OF THE DRAWINGS

In the following detailed description of the preferred embodiment, reference is made to the accompanying drawings that form a part hereof, and in which is shown, by way of illustration, a specific embodiment in which the invention may be practiced. It is to be understood that other embodiments may be utilized and structural changes may be made without departing from the scope of the present invention.

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

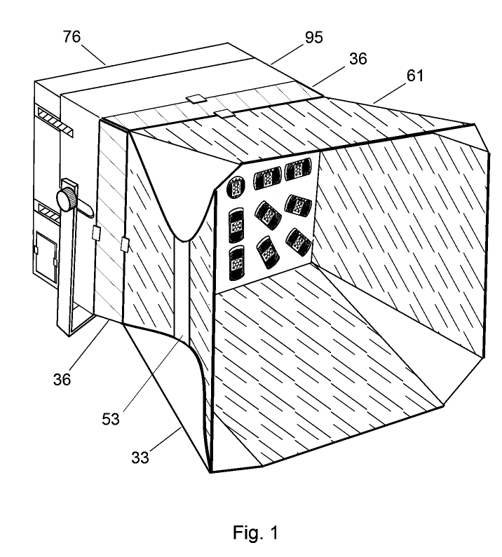

FIG. 1 is a perspective view of one embodiment of the LED fixture with the cases expanded, the flaps open and extended, and the curtains unfolded. FIG. 1 shows the expanded cases 76 with the outer case 95, the flaps open and curtains unfolded 61, the female hook and eye strip 53, the curtains 33 and diffusion doors 36. The curtains 33 may be unfolded and wrapped around the outside of the flaps, by way of the hook and eye 53 or similar attachment means, to block light from escaping. Diffusion doors 36 bridge the gap between the outer case and the flaps.

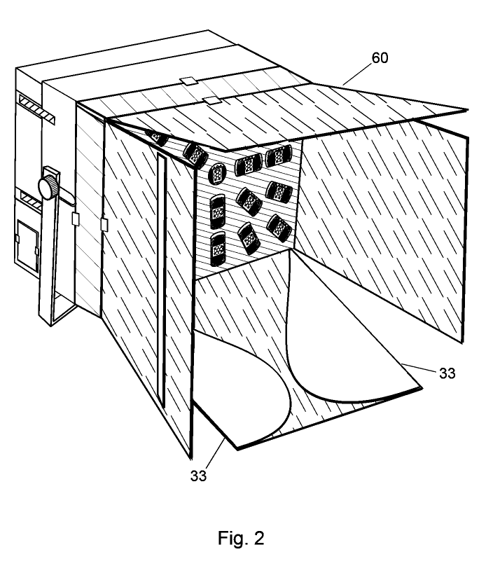

FIG. 2 is a perspective view of one embodiment of the LED fixture with the cases expanded, the flaps open and extended, and the curtains folded. FIG. 2 shows the expanded cases with the flaps open and the curtains folded 60, and the curtains 33 are folded and secured to the lower and upper flaps. In the best mode, four flaps are mounted to the front of the outer case with friction hinges to hold them in place. These flaps work independent of each other. When the flaps are open to the widest, the light can spill out and spread to its maximum. As the flaps are narrowed, the light will be removed from the outer areas when it is not needed. This allows the fixture to be set to light a specific object and not the area around it.

As seen in FIG. 2, when the flaps are wide open, there is a gap between the flaps and light leaks out. Curtains, mounted to the flaps, block the light that leaks out. There are four curtains and when not in use, they are held out of the way by hook and eye. Two of the curtains are mounted to the top flap and held in place by hook and eye, or similar attachment means, and the other two are mounted to the bottom flap. When in use, the curtains are released from the top and bottom flaps and wrap around the outside of the flaps. The curtains wrap over the opening between the flaps and block the light from escaping. Hook and eye, or similar attachment means, allows for adjustment and fit at any gap between the flaps.

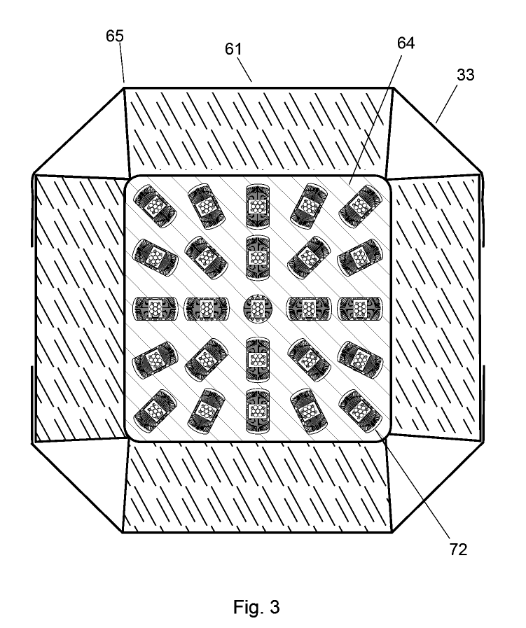

FIG. 3 is a front view of one embodiment of the LED fixture's LED configuration, with the flaps open and extended, and the curtains unfolded. FIG. 3 shows the front 65 of the invention with flaps open and curtains unfolded 61, curtains 33 around the fixture, the front cover 64, and heat sinks with LEDs 72. The front cover 64 has holes so that the LEDs on heat sinks 72 can move on their pivot points and the light emitted will not be blocked. The center heat sink is rigidly mounted so it only has a round hole. Behind each hole is a LED mounted on a heat sink 72.

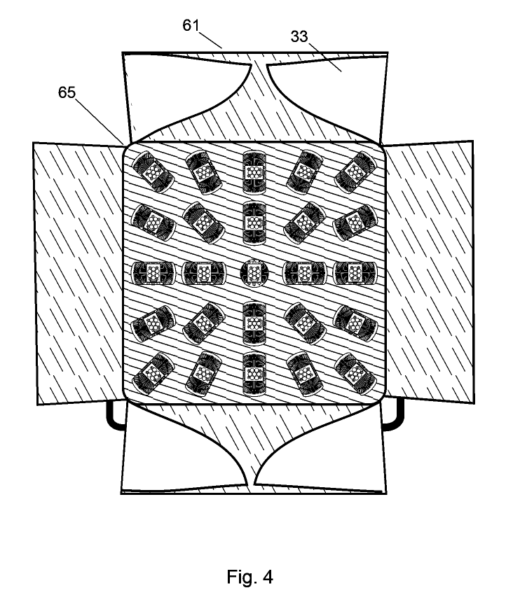

FIG. 4 is a front view of one embodiment of the LED fixture's LED configuration, with the flaps open and retracted, and the curtains folded. FIG. 4 is a view of the front 65 view of the fixture with the flaps 61 open and the curtains 33 folded.

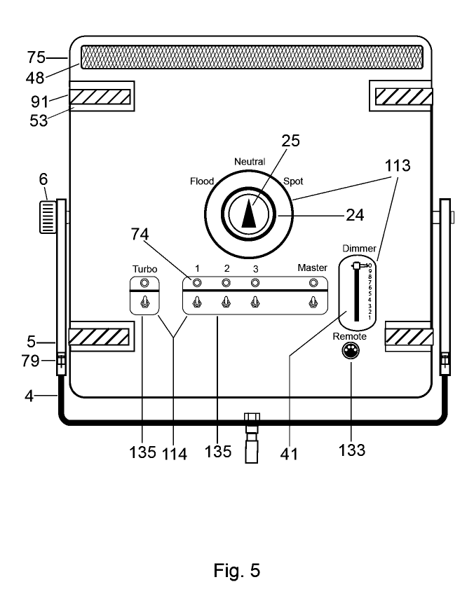

FIG. 5 is a rear view of one embodiment of the LED fixture, showing the bale, all the controls, the hook and eye tabs, and the exhaust vent. FIG. 5 shows the rear of the inner case 75 with male hook and eye tabs 91, female hook and eye tabs 53, the exhaust vent 48, the bale hand wheels 6, the bale extensions 5, the latch assemblies 79, the bale 4, the indicator lights 74, the recessed switch panels 114, the switches 135, the dimmer 41, the switch and dimmer remote control socket 133, the recessed knob area 113, the control knob 24, and the control knob position indicator 25. The tabs 91 and 53, which usually hold the expanding cases, are wrapped around the back of the fixture to hold it closed.

The electrical switches 135 include a master on/off switch, which controls all power to the fixture. The dimmer 41 also controls all circuits collectively. The circuit switches 135 control the circuits individually in designated patterns and a turbo switch eliminates the ninth LED when the nine LEDs are in series. These switches are located on the back of the fixture and are sunk into the fixture to protect the switches during transportation or storage. The switches are also angled upwards for easy accessibility. All the switches and the dimmer can be operated remotely through a hard wire, DMX, infra red and radio control.

In FIG. 5, when the turbo switch is up, it eliminates one of the nine LEDs in series, which increases the light output. When the switch is down, the ninth LED is connected and that circuit decreases in light output. The turbo switch is isolated from the circuit and master switches for clarity of operation. Indicator lights 74 give the visual status of each switch. When the switch is up, the indicator light 74 will illuminate, and will turn off when the switch is put down. Recessed switch panels 114 protect the switches by placing them back within the fixture. The switches are also angled up for easy accessibility. The circuit and master switches 135 also have a separation between them to avoid any accidental switching. The first switch lights the first circuit, the second switch lights the second circuit and the third switch lights the third circuit. The master switch lights all three circuits. The dimmer control 41 is counter-sunk for protection.

In FIG. 5, the remote socket 133 is where the remote control is plugged in, when use of the remote control is desired. Control knob 24 turns to change the position of the LEDs. When the knob is turned counterclockwise to the flood position, the LEDs point outward and spread the light out. When the knob is pointed towards the neutral position, the LEDs point straight out. When the knob is turned clockwise to the spot position, the LEDs point to the center and concentrate the light output. The recessed knob area 113 countersinks the knob into the fixture to protect the knob from damage. Control knob position indicator 25 is an arrow on the back of the control knob 24 that moves with the control knob 24 to indicate its relation to the flood, neutral, and spot positions.

The bale 4 functions as a tilting device, allowing the user to tilt the fixture up and down or left and right. The bale 4 also telescopes out using bale extensions 5 to make it longer, allowing the fixture to tip down without hitting the bale. There are latches 79 to hold the bale in either the retracted of expanded position. To retract the bale 4, a user holds the top extension 5 and pushes both latches 79 at the same time. This action helps to avoid the fixture from slamming downward.

The LED position control mechanism 24 moves the heat sinks and changes their direction. The heat sinks are angled to the center of the fixture. The heat sink sits on two aluminum mounts that allow the heat sink to pivot or rock and change its angle and direction. Although the heat sinks can be stopped in many positions, there are three basic positions: neutral, flood, and spot.

It is not necessary for the center heat sink to move, so it is isolated, mounted rigidly, and not connected to the LED position mechanism. A control knob 24 protrudes out of the back of the fixture and controls the action of the pivoting LEDs. It can be turned clockwise and counter clockwise. When the knob is in the center, it is in the neutral position. When it is turned counterclockwise, it is in the flood position. When turned clockwise, it is in the spot position. Notches hold the control knob in the designated position.

Exhaust vent 48 is part of the ventilation system and is where air that has circulated thru the fixture to remove heat from the heat sinks exits into the atmosphere. Male hook and eye 91 and female hook and eye 53 are used to secure the inner case and outer case in any desired position.

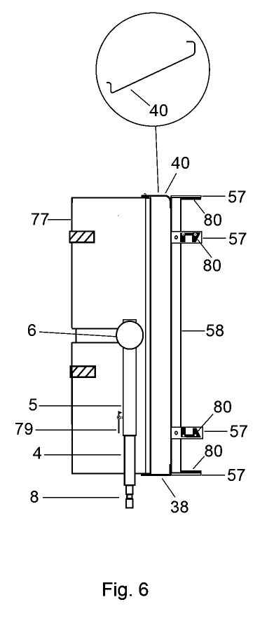

FIG. 6 is a right side view of one embodiment of the cases in a retracted position, without the flaps, without the diffusion door and with the flap-retaining bracket 58, which holds the necessary hardware to mount the flaps to the outer case. FIG. 6 shows the inner cases retracted 77 with the diffusion holder top piece 40, bale hand wheel 6, bale extension 5, latch assembly 79, bale 4, bale pin 8, diffusion holder bottom rail 38, flap retaining bracket assembly 58, flap retaining brackets 57, and latch catch 80. The bale hand wheel 6, when loosened, can be tipped up and down, and when the hand wheel is tightened, the bale 4 is locked in place. The bale extensions 5 make the bale 4 longer so the fixture can tilt down without hitting the bale 4.

In FIG. 6, the bale is in the retracted position. The latch assembly 79 locks the bale 4 in the expanded or retracted positions. The bale 4 is used to pan and tilt the fixture, allowing the fixture to point anywhere. The bale pin 8 allows the fixture to be mounted to a stand or hanging device. The diffusion holder bottom rail 38 and diffusion holder bottom rail 40 work together to insert, remove, and to hold diffusion or color corrections that may be used. There are three ways to insert diffusion of color corrections into the diffusion track. Diffusion or color corrections can be inserted into the diffusion area from the top or from either side. This is possible due to the special shape of the diffusion door top piece 40.

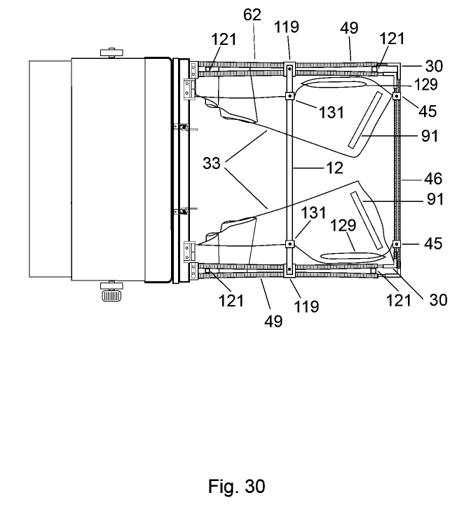

The diffusion holder bottom rail 38 is located at the outer edge of the outer case. This is where diffusion and color corrections sit or rest on when they are inserted. The diffuser softens the light and color corrections alter the color temperature. A specially designed bracket 40 at the top allows the three way insertion. The flap retaining bracket assembly 58 has all the flap retaining brackets mounted to it. The flap retaining bracket 57 which contains the latch catch 80 accepts the latch hook (FIG. 30, item 81) to mount the flaps to the fixture. Only one of the two catches on each flap needs to be released for removal. The other latch, when the flap is pulled to the side, will slide past the latch catch and release.

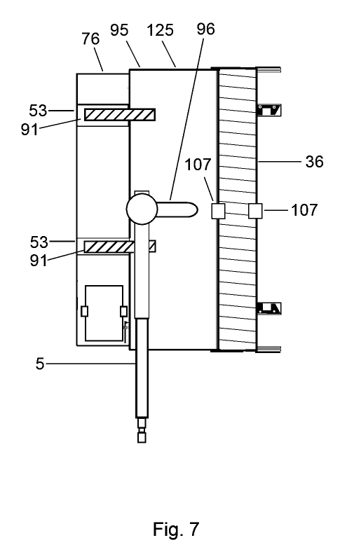

FIG. 7 is a right side view of one embodiment of the cases in an expanded position, without flaps mounted, and with the diffusion door. FIG. 7 shows the side view of the cases expanded 125 with the inner case 76, the outer case 95, female hook and eye strips 53 and male hook and eye strips 91, diffusion door 36, with pull tabs 107, outer case expanding slot 96 and bale extension 5. The high-powered LED lighting unit consists of a two cases an inner case 76 and outer case 95. The inner case 76 shown expanded contains all of the electrical, electronic, and mechanical components needed for the LED light to function as an illuminating fixture. The outer case 95 serves as a platform for the hardware that alters and controls the light emitting from the LEDs.

As seen in FIG. 7, the inner case fits within the outer case. When in use, the adjustable cases can separate to expand and make the unit longer, with stops to keep the cases from over-extending. When not in use or in storage, the inner case slides within the outer case. The two cases lock in a user's desired setting using hook and eye strips 53 and 91. The expanding cases serve two purposes. First, when the cases are contracted, they have a smaller profile, making them more portable and thereby taking up less space in transit or storage. Second, when expanded, they increase the distance between the LEDs mounted within the inner case and the diffuser that is inserted at the front of the outer case, thus creating a softer, more even light and eliminating the multiple shadows created by the LEDs.

Three diffusion doors 36 are attached to the outside edge of the outer case. One on the top and one on each side. A diffusion door is not needed on the bottom as the diffusion track (FIG. 6, item 38) serves as a shelf. These diffusion doors bridge the gap between the outer case and the adjustable light controlling flaps. These diffusion doors have three functions. One is to block any light that spills out from the gap between the outer case and the adjustable light controlling flaps. A second function is to work as doors, so diffusion or color corrections can be inserted into the diffusion track. A third function is to hold in the diffusion or color corrections so they do not fall out. The diffusion door 36 straddles the outer case 95 and the flap retaining bracket (FIG. 6, item 58). The diffusion doors are made of plastic and held on by hook and eye tabs 107 mounted to both sides of the diffusion door 36. The hook and eye tabs that are mounted to both sides of the diffusion door are for easy opening as the door can be opened from either side, because the hook and eye tabs also serve as a hinge. The outer case expanding slot 96 allows the outer case to slide back and forth to any adjusted setting. Bale extension 5 allows the bale to be extended or retracted as needed and is in the expanded position which allows the fixture to tilt down at a greater angle.

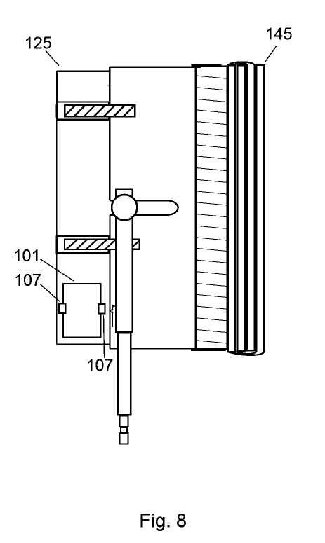

FIG. 8 is a right side view of one embodiment of the cases in an extended position, with the flaps mounted and folded. FIG. 8 is a side view of the invention with the cases expanded 125 and the flaps folded closed 145, the power cord storage door 101 with pull tabs 107. When in storage or transit, the power cord is inserted into the storage compartment where it is out of the way and will not get tangled with other objects. The power cord storage door 101 is mounted with hook and eye tabs 107 on both sides so that it can be opened from either side to allow easy access to open the door as the hook and eye also serves as a hinge.

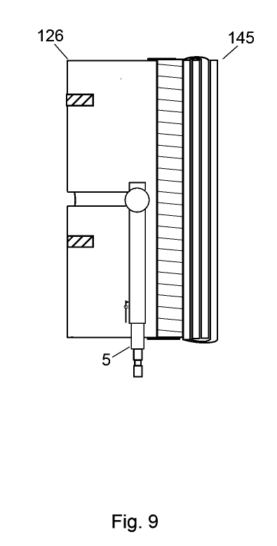

FIG. 9 is a right side view of one embodiment of the cases in a retracted position, with the flaps mounted and folded. FIG. 9 is a side view of the invention with the cases retracted 126, the flaps folded closed 145, and the bale extensions 5 retracted. When not in use, the four flaps can be folded in flush with the front of the fixture. The bottom flap is folded in last and hook and eye is used to secure the flaps in place. This is the way it would typically be transported or stored because it takes up less space and allows for maximum protection of the components of the fixture.

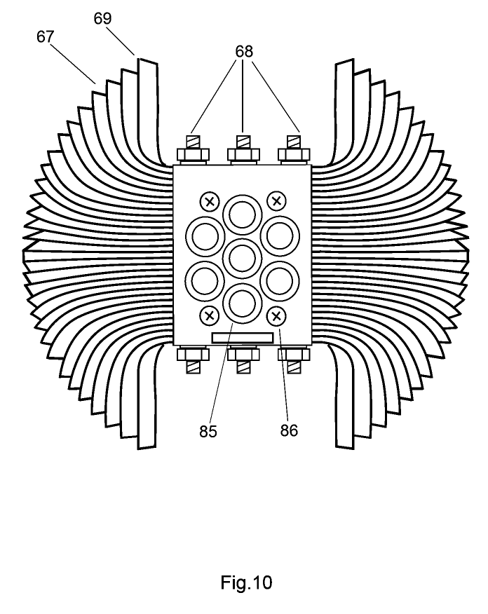

FIG. 10 is a front view of one embodiment of the LEDs mounted on the heat sink. FIG. 10 shows the heat sink 67 with the heat sink compression screws 68, the heat sink fins 69, the LEDs 85 and the LED mounting screws 86. The unit uses high-powered LEDs 85, which requires the LEDs 85 to be mounted on heat sinks 67, as LEDs 85 can reach extreme temperatures and will result in catastrophic results if not mounted on heat sinks. The heat sink 67 is made of strips, preferably aluminum, cut to equal lengths and compressed in the center by compression screws 68. The strips are them fanned out so that they are separated, then twisted to an angle, preferably 15 degrees, to form fins 69. Heat sink compound is applied between the strips at the compression area to further aid in the heat transfer process. On one side, an area is compressed and machined to make a smooth surface for the LED to sit on and to make a good heat transferable surface. The heat sink 67 is mounted using screws 86 on the four holes of the LED pad, and heat sink compound is applied between the LEDs 85 and the heat sink 67.

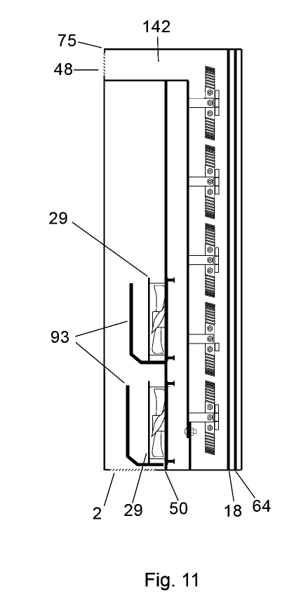

FIG. 11 is a right side view of one embodiment of the inner case of the ventilation system. FIG. 11 shows the ventilation system inside the inner case 75 with an exhaust vent 48, ventilation partition 142, cooling fans 29, noise baffles 93, fan mounting plate 50, an air intake 2, a clear plastic cover 18, and a front cover 64. The inner case 75 is completely enclosed, except for the air intake vent 2 located on the bottom of the fixture, which draws in cool air, and the exhaust vent 48 located on the top back of the fixture, which lets the heated air out.

The fans 29 are ultra quiet and create convection within the fixture. The fans 29 are mounted to the fan mounting plate 50, which has holes for the air to circulate and is elevated along the bottom to also circulate air pushed by the fans 29. Noise baffles 93 deflect the noise of the fans 29 for quiet operation. The ventilation partition 142 seals off the inner case 75, creating a pathway for the air pushed by the fans. The clear front cover 18, mounted to the inside of the front cover, keeps the air from escaping out the front of the fixture, maintaining a closed circulating system of convection. The front cover 64 has holes but the clear front cover 18 blocks the air from escaping and allows air to circulate.

The ultra-quiet internal fans 29 are mounted inside the fixture to further aid in cooling the LEDs. With the use of noise baffles 93 and a partition 142, the noise of the fans is inaudible. The interior of the fixture is lined with noise-deadening material to further lessen the noise of the fans. The inner case 75 is designed so that a convection of air is produced by air entering from a vent in the bottom and an exhaust outlet on the top to ventilate and cool the LEDs.

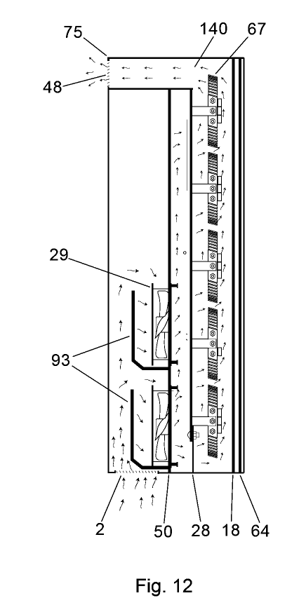

FIG. 12 is a right side view of one embodiment of the ventilation system, with arrows that show ventilation flow within the fixture. FIG. 12 shows the inner case 75, with arrows that show the ventilation flow 140 within the fixture, an exhaust vent 48, cooling fans 29, noise baffles 93, an air intake 2, a fan mounting plate 50, a control mechanism mounting plate 28, heat sinks 67, a clear plastic cover 18, and a front cover 64. Cool air enters through the air intake 2 at the bottom of the fixture. When the air is drawn in, it flows past the noise baffles 93 and is then pushed by the fans 29 through the holes in the fan mounting plate 50 to enter the chamber between the fan mounting plate 50 and the control mechanism mounting plate 28. It then passes through holes in the control mechanism mounting plate 28 and enters the front chamber where the heat sinks 67 are located. The clear front cover 64 keeps air from escaping out the front of the fixture. The air then passes over the heat sinks 67, taking heat off the heat sinks and out through the exhaust vent 48 on the back of the fixture.

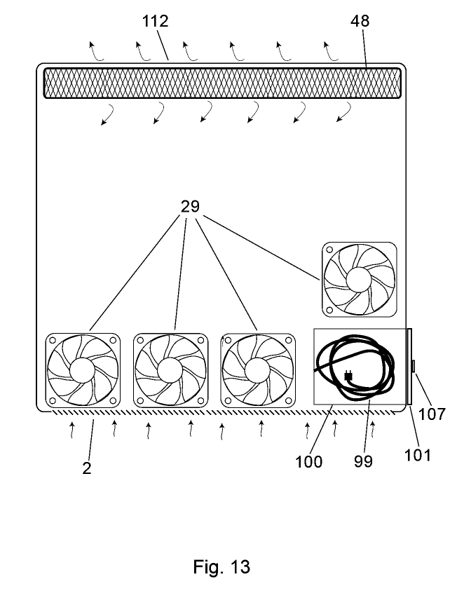

FIG. 13 is a back view of one embodiment of the ventilation system's fan configuration, power cord storage area, and power cord storage door, with arrows that show the direction of circulation. FIG. 13 shows the rear view 112 of the ventilation system with an exhaust vent 48, cooling fans 29, the power cord storage box 100, the power cord 99, the power cord storage door 101, pull tabs 107, and the air intake 2. The view shows how the cooling fans 29 are configured around the power cord storage box 100 and also shows the power cord storage door 101 and the power cord 99. Arrows show the air entering from the bottom air intake 2 and out the top through the exhaust vent 48.

A power cord 99 supplies the fixture with 120 volts AC to the power supplies. The power supplies rectify and properly regulate the power to the LEDs. When not in use, the power cord can be inserted into a compartment within the fixture. The power storage compartment 100 has a door to contain the power cord. The door is made of plastic and is held in place by hook and eye tabs 107.

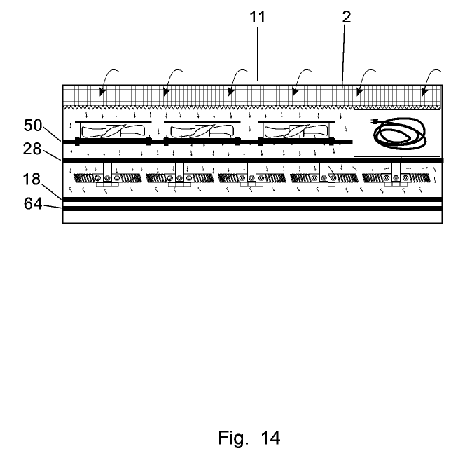

FIG. 14 is a bottom view of one embodiment of the ventilation system. FIG. 14 shows the bottom 11 of the fixture, with the air intake 2, the control mechanism mounting plate 28, the clear plastic cover 18, the fan mounting plate 50, and the front cover 64. Air is drawn in from the air intake vent 2, and passes thru holes in the fan mounting plate 50, and then passes thru holes in the control mechanism mounting plate 28 into the heat sink chamber, and out the exhaust vent (FIG. 13, item 48). The clear front cover 18 blocks the air from escaping thru the holes in the front cover 64.

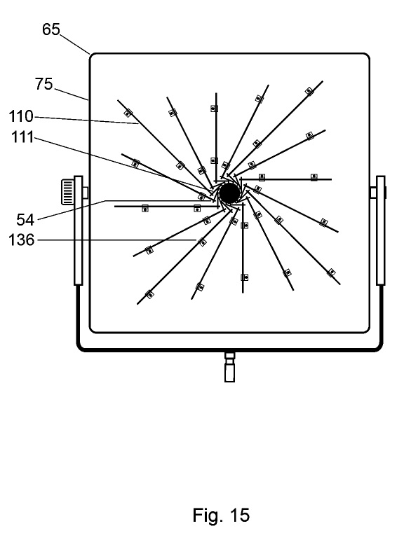

FIG. 15 is a front view of one embodiment of the inner case with the radial arms, radial fingers, and brackets. FIG. 15 shows the front view 65 of the inner case 75, with the radial arms 110, the radial fingers 111, the finger and arm connections 54, and the fluoropolymer brackets 136. The radial arms 110 are connected to the radial fingers 111 at the finger and arm connection 54. The radial finger 111 protrudes through a hole in the radial arm 110. The radial arms 110 are mounted using the fluoropolymer brackets 136, which allow radial arms 110 to slide within them easily without lubrication. The fluoropolymer brackets 136 secure the radial arms from slipping out of the radial fingers 111.

A shaft is connected to the control knob. The other end of the shaft is connected to the wheel which has rods (called fingers) that come out of the wheel at 90-degree angles. These fingers protrude through a hole in the radial arms to push and pull them, causing them to move the connecting rod. The connecting rod attaches to the radial arm and to one of the end screws that holds the heat sink together. As the radial arm moves, it also moves the connecting rod, which pivots the heat sinks and changes their direction. These arms are held in place by brackets, which hold the radial arms in place and allows the radial arms to easily slide within the brackets without lubrication.

The connecting rods are made of fluoropolymers to electrically isolate the heat sinks from each other, as each heat sink has a positive potential and in a series circuit would create a short circuit. When material is placed in front of the light in the diffusion track to soften the light, the spot, flood and neutral positions are also affected. The spot position of the light concentrates the light on the surface of the diffuser and makes the light harder with defined shadows and maximum intensity. The neutral position, where the heat sinks are facing straight out, gives the most even spread of light, which optimizes spread and intensity. The flood position faces the LEDs outward, creating a softer light and decreased intensity. The position control mechanism can also be controlled by servo motors mounted within the fixture with a potentiometer mounted on the back of the fixture. The servo can also be operated remotely using hard wire, DMX, infra red, or radio control.

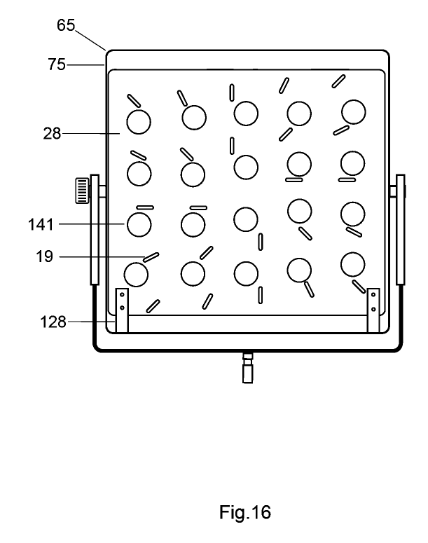

FIG. 16 is a front view of one embodiment of the inner case, with the control mechanism mounting plate attached. FIG. 16 shows the front 65 of the inner case 75, with the control mechanism mounting plate 28 installed, the ventilation holes 141, the connecting rod holes 19, and the spacer/mounting foot 128. The hardware is mounted to the back of the control mechanism mounting plate 28. The control mechanism mounting plate 28 has ventilation holes 141 and holes for the connecting rods 19 to pass through to connect the heat sink to the radial arms. The control mechanism mounting plate 28 is mounted on feet 128 that elevate the plate so that the fans can push air under the plate to the LEDs.

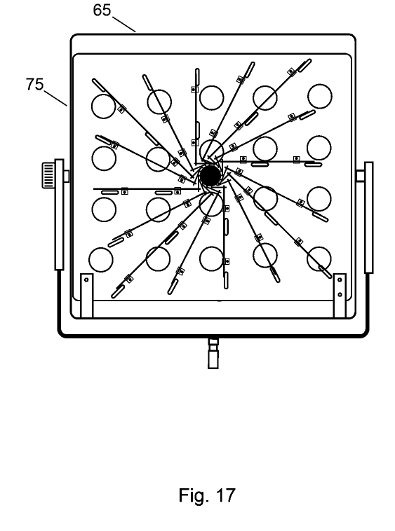

FIG. 17 is a front view of one embodiment of the inner case, with the control mechanism mounted on the mounting plate. FIG. 17 shows the front view 65 of the inner case 75, which shows the two previous views combined with the radial arms and radial fingers mounted to the control mechanism plate.

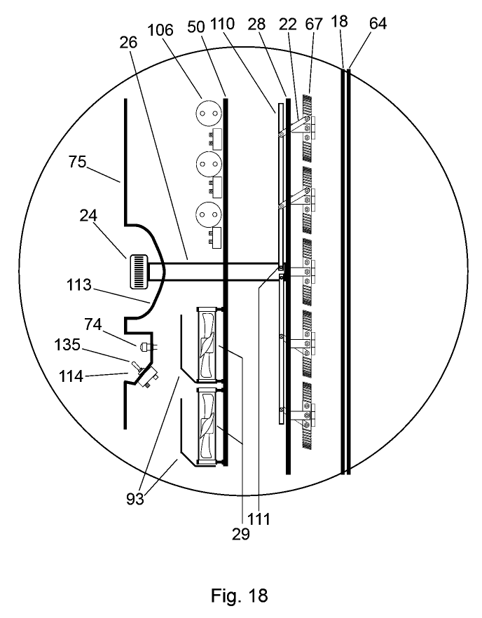

FIG. 18 is a magnified, right side cross section view of one embodiment of the inner case. FIG. 18 is a right side cross section view, magnified to show how the different layers of the fixture are configured. FIG. 18 shows the inner case 75, with the control knob 24, the recessed knob area 113, the indicator lights 74, the switches 135, the recessed switch panels 114, the control knob shaft 26, the noise baffles 93, the cooling fans 29, the radial fingers 111, the power supply 106, the fan mounting plate 50, the radial arm 110, the control mechanism mounting plate 28, the connecting rod 22, the heat sinks 67, the clear plastic cover 18, and the front cover 64.

Inner case 75 is cut to show the recessed knob area 113 and the recessed switch panels 114. The indicator lights 74 and switch 135 are shown mounted in the safety of the recessed areas. Noise baffles 93 deflect the noise made by the fans 29 for quiet operation. Power supplies 106 are shown mounted to the fan mounting plate 50 along with the fans and baffles. Radial arms 110 are shown mounted on one side of plate 28 and the heat sinks 67 mounted on the other side of the plate with the connecting rods 22 passing through the plate connecting the two together. When control knob 24 is turned, the fingers 111 pull when turned in one direction and push when turned in the other direction. This pushing and pulling causes heat sinks 67 to respond by moving on their pivot point, changing the direction of the light. Again, the clear front cover 18 blocks the air from the holed front cover 64 from escaping.

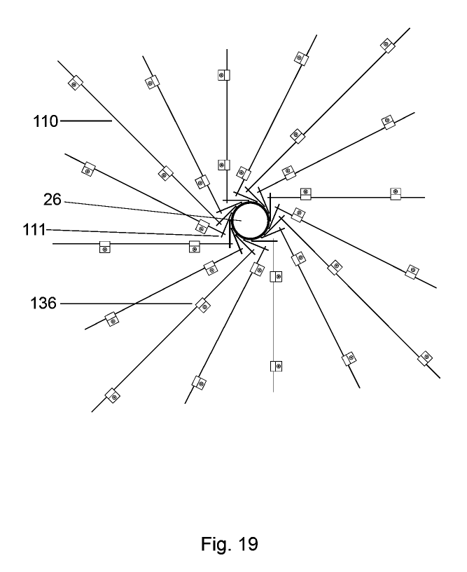

FIG. 19 is a front view of one embodiment of the radial arms, radial fingers and brackets. FIG. 19 is a front view of the radial arms 110, radial fingers 111, control knob 26, and brackets 136. This view shows how the radial arms 110, radial finger and arm connection 54 and the fluoropolymer brackets 136 work together to rock the heat sinks on their pivot points and change their direction.

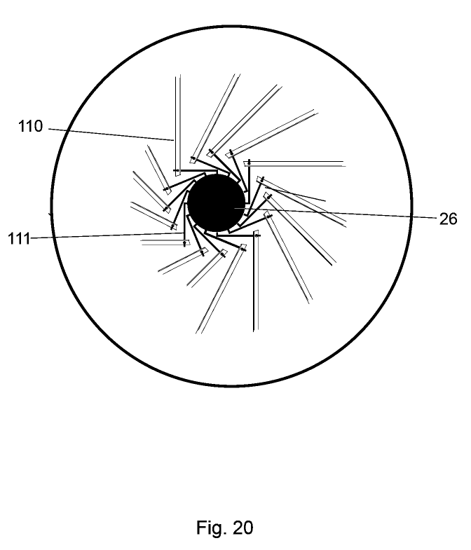

FIG. 20 is a magnified view of one embodiment of the radial arms 110 and fingers 111 showing the control knob 26.

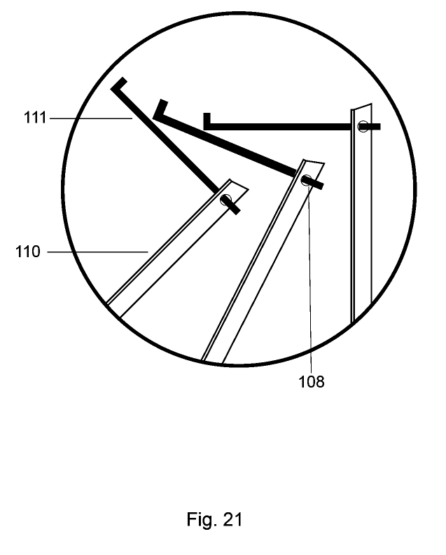

FIG. 21 is a further magnified view of one embodiment of the radial arms 110 and fingers 111. This figure shows how the radial fingers 111 protrude through a hole in the radial arm 110 to form a radial arm and finger connection 108.

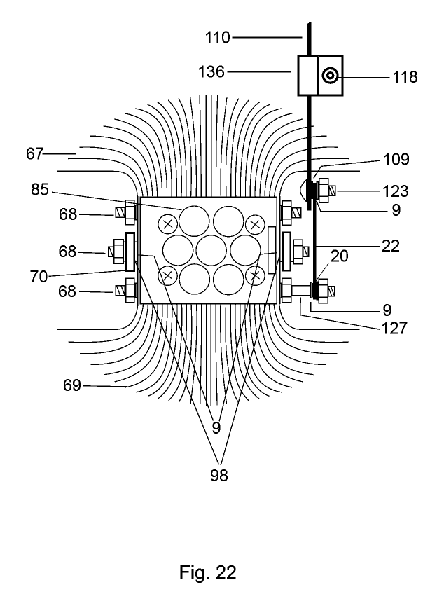

FIG. 22 is a top view of one embodiment of the heat sink 67 with LEDs 85 attached. FIG. 22 shows the heat sink 67 with radial arm 110, rivet 118, fluoropolymer bracket 136, radial arm to connecting rod 109, screw 123, bearing 9, connecting rod 22, spacer 127, connecting rod to heat sink 20, pivot point 98, heat sink fin 69, heat sink compression screw 68, heat sink mount 70, and LED 85. The heat sink compression screws 68 compress the aluminum strips to efficiently transfer heat from the LED 85 to the heat sink fins 69, where heat is dissipated into the atmosphere. The heat sink 67 is mounted to the heat sink mounting board using the heat sink mount 70 and the center compression screw 68. A bearing 9 allows the nut on the center screw 68 to be tightened to compress and still allow the heat sink 67 to pivot at a pivot point 98. Radial arm 110 passes through the fluoropolymer bracket 136, which is held in place by a rivet 118. The end of the radial arm 110 is attached to the connecting rod 22 at connecting rod point 109. It is held together by screw 123 which has a bearing 9 that allows the nut on that screw to be tightened to compress the heat sink 67 and still allow the connecting rod 22 and the radial arm 110 to move freely. The other end of the connecting rod 22 is mounted to one of the outer screws on the heat sink 67 at the connecting rod 22 to heat sink point 20. A spacer 127 extends the screw out so that the control rod 20 will not hit the other screws. A bearing 9 allows the screw to compress the heat sink 67 and allows the connecting rod 22 to move freely.

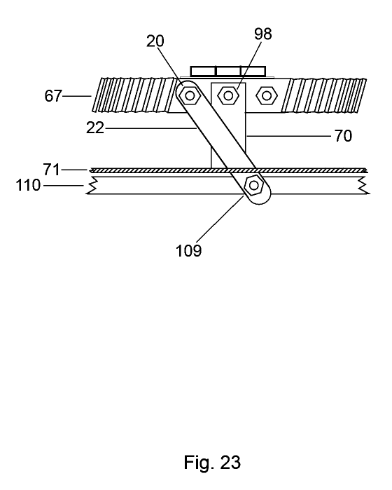

FIG. 23 is a side view of one embodiment of the heat sink. FIG. 23 shows the heat sink 67 with connecting rod to heat sink 20, pivot point 98, connecting rod 22, heat sink mount 70, heat sink mounting board 71, radial arm 110 and radial arm to connecting rod 109. FIG. 23 shows the relationship between the heat sink 67, the connecting rod 22 and the radial arm 110. The radial arm 110 is shown on the bottom side of the heat sink mounting board 71. The connecting rod 22 passes through the heat sink mounting board 71 to connect to the radial arm 110. Connecting rod 109 connects to the heat sink using the connecting rod to heat sink 20 connection. The heat sink 67 sits on a heat sink mount 70 and pivots at pivot point 98.

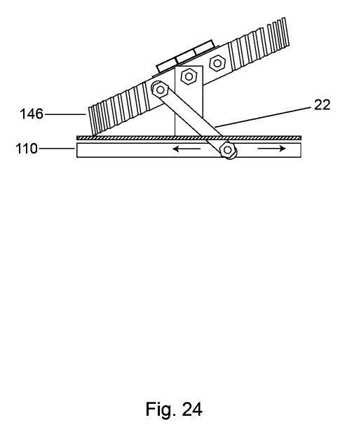

FIG. 24 is a side view of one embodiment of the heat sink, shown tilted. FIG. 24 shows how the tilted heat sink 146 will tilt down when the radial arm 110 moves to the right. If the radial arm 110 moves to the left, it will push on the connecting rod 22, which will in turn push the tilted heat sink 146 and move it in the other direction.

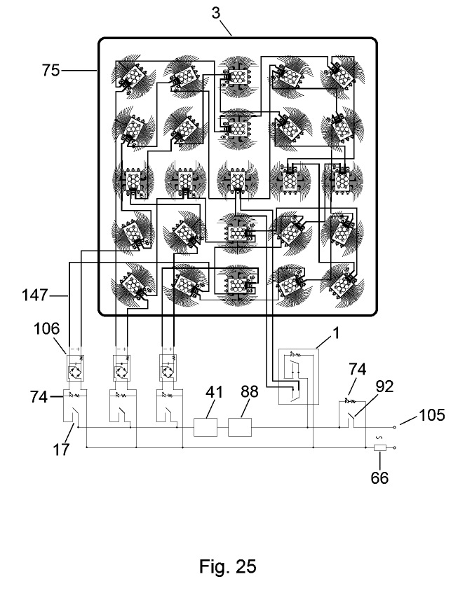

FIG. 25 is a front view of one embodiment of the inner case that shows all of the LED electrical circuits. FIG. 25 shows all three of the electrical circuits 3 of LEDs, with the inner case 75, connecting wires 147, power supply 106, indicator lights 74, circuit switches 17, dimmer 41, line conditioner 88, ninth LED circuit switch 1, master switch 92, power input 105, and fuse 66. The heat sinks with LEDs are in series and are divided into three circuits 3. Two circuits have eight LEDs in series and one circuit has nine LEDs in series. The circuits are divided into patterns so that each circuit maintains an even spread of light. Each circuit is individually powered with its own power supply 106, an indicator light 74, and a circuit switch 17.

The circuits of LEDs are in a rectangular configuration. Some circuits have eight LEDs in series and other circuits have nine LEDs in series. The circuits with nine LEDs in series have a turbo switch, which eliminates one LED from the series, leaving a circuit of eight in a series. Eliminating one LED from the series increases the output of that circuit, thus giving the user two different light densities from one circuit of LEDs. Each circuit has its own power supply 106 mounted internally within the inner case.

Line conditioner 88 helps to stabilize the AC Power and eliminate line fluctuations that may occur. Dimmer 41 is in series with all three circuits 3 and affects them all at the same time. The power input is 120 Volts AC 105 and is protected by a fuse 66. Master switch 92 also controls power to all three circuits 3 and an indicator light 74 illuminates when the master switch 92 is in the “On” position. The ninth LED circuit switch 1, also called the Turbo Switch, eliminates one LED from the circuit with nine LEDs in series. The all circuits 3 view shows all the circuits as combined. The power supply 106 is connected to the LEDs by connecting wires 147.

A line conditioner 88 or stabilizer keeps power line interference from causing a fluctuation in the light emitted from the LEDs. The AC line stabilizer compensates for interference in the power being supplied to the LED fixture. LEDs are sensitive to changes in the input power. An electric motor can cause a wobble in the input power, causing the LED fixture to react similarly, and causing the light output to vary. The line conditioner or stabilizer will also prevent the light from dipping when another device on the same AC line is turned on.

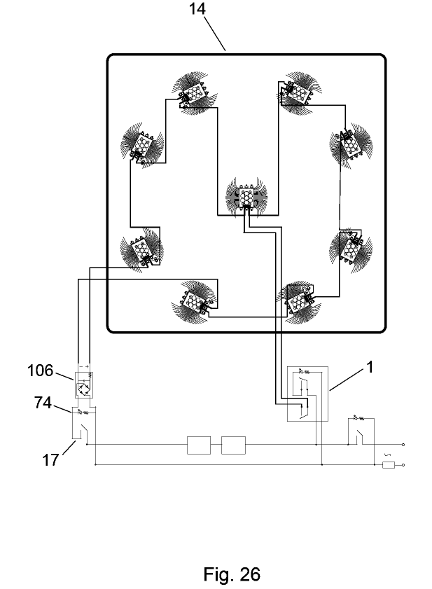

FIG. 26 is a front view of one embodiment of the inner case that shows the first circuit. FIG. 26 shows the configuration of the first circuit 14 in a circular pattern, 9^{th} LED switch 1 (turbo switch), power supply 106, indicator light 74, and switch 17. The arrangement of the nine LEDs is spread evenly. The circuit has the capability to eliminate one LED with the ninth LED circuit switch 1 and have only eight in series to increase the output or, the ability to turn the ninth LED on and have all nine in series, which decreases the light output. In FIG. 26 the center LED can be eliminated. This circuit has its own separate switch 17, power supply 106 and indicator light 74.

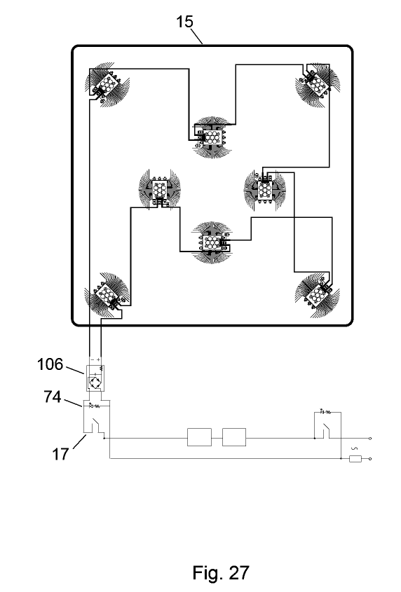

FIG. 27 is a front view of one embodiment of the inner case that shows the second circuit. FIG. 27 shows the configuration of the second circuit 15 with a series of eight LEDs spread evenly, power supply 106, indicator light 74, and switch 17. This circuit has its own separate switch 17, power supply 106 and indicator light 74.

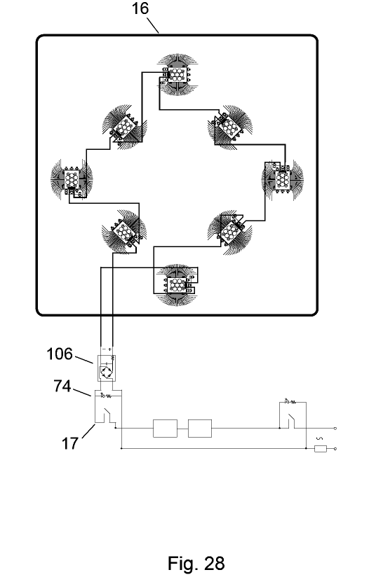

FIG. 28 is a front view of one embodiment of the inner case that shows the third circuit 16, the power supply 106, indicator light 74, and switch 17. FIG. 28 shows the configuration of the third circuit 16 with a series of eight LEDs spread evenly in a diamond arrangement. This circuit has its own separate switch 17, power supply 106 and indicator light 74.

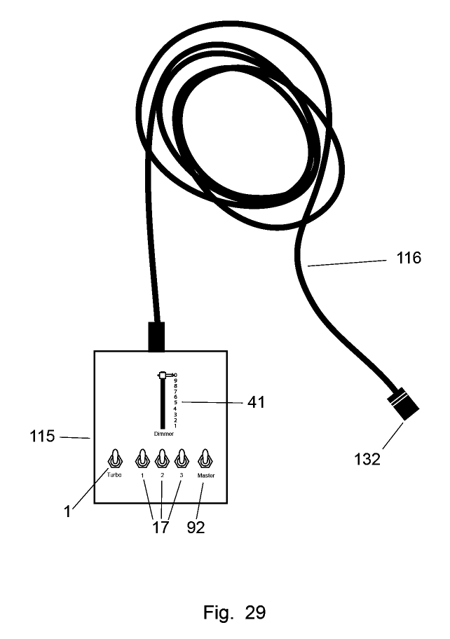

FIG. 29 is a front view of one embodiment of the remote control box. FIG. 29 shows the remote control box 115 with the remote control cable 116, the switch and dimmer remote control plug 132, the dimmer 41, the ninth LED circuit switch 1, the circuit switches 17, and the master switch 92. This box is used to control the fixture from a distance. The switch and dimmer control socket 132 plugs into a socket on the back of the fixture. When this box is plugged in, the remote overrides the switches 17 and dimmer 41 mounted on the fixture so that the fixture is controlled by the switches on the remote control box 115. The switches include the ninth LED switch 1 (also called the Turbo Switch), the three circuit switches 17, the master switch 92 and the dimmer 41. The cable 116 can be extended so that the fixture can be operated from a lengthy distance, such as 100 feet.

The remote control box plugs into the remote control socket and allows the fixture to be controlled from a distance when it placed in an inaccessible place, such as being hanged or raised high on a stand. The box will override the switches and dimmer on the fixture. The cable mounted to the remote can be of various lengths, and extensions can be added to extend the control box to a length of one hundred feet or more.

A dimmer dims the LEDs when less light is needed. The dimmer is preferably a standard neon dimmer, and is in series with the LED circuits. The knob that controls the dimmer protrudes through the back of the fixture for adjustment. The dimmer controls the light from 0 percent to 100 percent. As a factory setting, turning the dimmer clockwise dims the light and turning it counter-clockwise increases the light. Since that configuration is contrary to other dimmers used in the movie industry, the factory settings are reversed to have continuity with other dimmers. Clockwise will increase the light and counter-clockwise will decrease the light. The dimmer also has a remote function, which allows it to be controlled remotely through a hard wire, DMX, infra red or radio control device.

FIG. 30 is a top view of one embodiment of the case in an expanded position, with open and retracted flaps and folded curtains. FIG. 30 is a top view of the fixture with flaps open but retracted 62, rod separator 121, rod pinch bracket 119, extending rods 49, corner connector 30, string 129, end rod restraint 45, male hook and eye tab 91, end rods 46, center support 12, string retainer 131, and curtains 33. The flap cover has been removed to show the inside workings of the fixture. There is a rod separator 121 at each end of the extending rods 49. Rod separator 121 keeps the extending rods 49 spread apart to create friction at the pinch point 119 so that the extending rods 49 will stay in place when adjusted. End rods 46 are held together by the end rod restraint 45. Male hook and eye tab 91 holds the curtains 33 in place by connecting to hook and eye on the flap cover (not shown). String 129 is relaxed when the flap is retracted and string retainer 131 keeps the string from becoming tangled. Curtains 33 are also retracted and gathered at one end. Center support 12 gives the flap stability from flexing and has a rod pinch bracket 119 mounted at each end. Corner connectors 30 hold the end rods 46 and the extending rods 49 together.

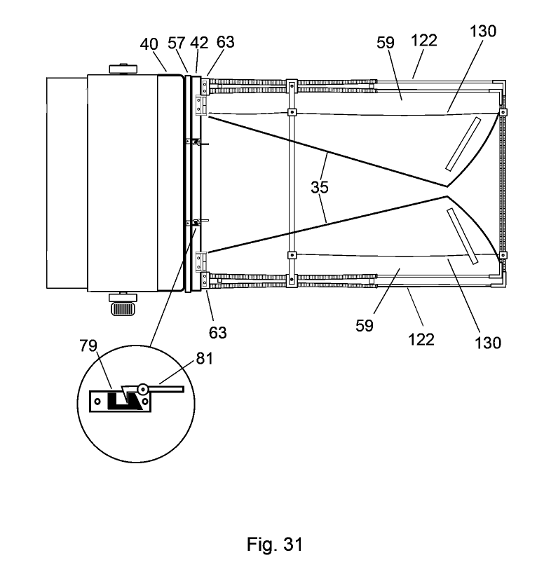

FIG. 31 is a top view of one embodiment of the case in an expanded position, with open and extended flaps and folded curtains. FIG. 31 shows the flaps extended 59, diffusion top piece 40, flap retaining bracket 57, end brace 42, friction hinge 63, extended rods 122, string extended 130, latch assembly 79, extended curtains 35, and latch hook 81. The expanding rods 122 are shown extended out. String 130 is shown extended to keep the flap from over-extending. Curtains 59 are extended and the gathering at one end is stretched out. Diffusion holder top piece 40 is shown followed by the flap retaining bracket 57 to which the latch assembly 79 is attached. Latch hook 81 is mounted to the end brace 42. When the flap retaining bracket 57 and the end brace 42 are joined together the latch hook 81 slips into the latch assembly 79 and secures the flaps to the fixture. To remove the flaps only one latch hook 81 needs to be released as the other latch hook will slide out when the flaps are moved to the side. Friction hinges 63 are also mounted to the end brace 42 and allows the flaps to open and close and holds them in a user's desired position.

The friction hinges 63 allow the flaps to move to an open or closed position or to stay in any position that may be required. The flaps are made of carbon fiber rods of two sizes. One fits inside the other, allowing them to telescope so the flaps can be made longer or shorter, depending on the requirements desired. There is a double row of carbon fiber rods for strength and durability. The carbon fiber rods are joined at the corners to form a rectangle. The flaps are then covered by a lightweight opaque material to block light. Inside the flaps are two strings to keep the flaps from telescoping beyond the ends of the carbon fiber and coming apart. A center support with brackets on each end pinches the rods and works with the rod separators on the ends, creating friction which allows the rods to stay in a user's desired position.

These flaps can easily also be removed if not needed by using a quick release spring latch 81. Each flap has two easy-release latches 81 to easily attach and remove the flaps from the flap retaining bracket. Only one latch 81 needs to be released to remove the flaps. When one latch 81 is released and the flap is pulled outward, the second catch slides past the catch and the flap comes off.

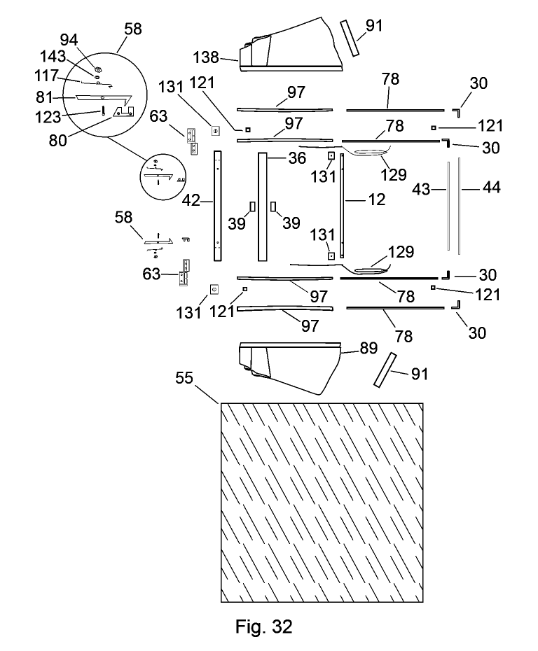

FIG. 32 is an exploded view of one embodiment of the flap assembly. FIG. 32 shows the flap assembly with center support 12, corner connector 30, end brace 42, diffusion holder pull tab 39, diffusion door 36, friction hinge 63, flap retaining bracket assembly 58, latch catch 80, latch hook 81, flap cover 55, lower curtain 89, male hook and eye tab 91, inner extending rod 78, outer extending rod 97, end rod outer 44, end rod inner 43, rod separator 121, string retainer 131, upper curtain 138, string 129, screw 123, return spring 117, washer 143, and nut 94.

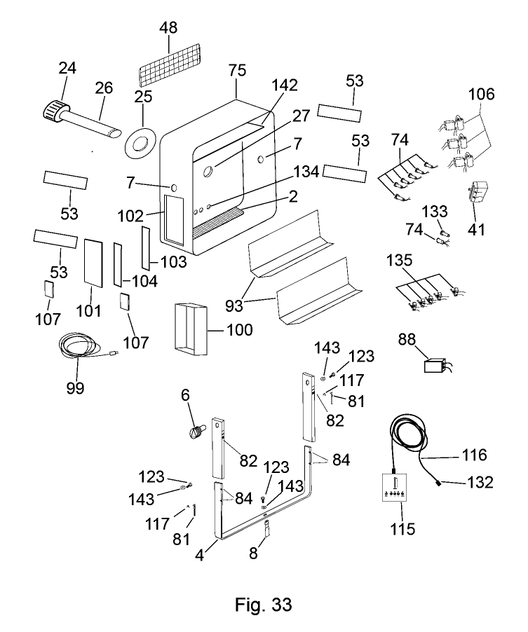

FIG. 33 is an exploded view of one embodiment of the inner case. FIG. 33 shows the inner case 75 with air intake 2, bale hand wheel 6, bale mount hole 7, bale 4, bale pin 8, dimmer 41, female hook and eye strip 53, indicator lights 74, control knob shaft hole 27, control knob position indicator 25, control knob 24, control knob shaft 26, exhaust vent 48, pull tab 107, power cord storage door 101, power cord storage door opening 102, power cord storage door female 103 and male 104 hook and eye, power cord 99, noise baffle 93, power cord storage box 100, latch hook 81, latch mount 82, latch notches 84, line conditioner 88, switch and dimmer remote control socket 133, switch 135, switch mounting holes 134, ventilation partition 142, washer 143, screw 123, return spring 117, remote control cable 116, switch and dimmer remote control plug 132, remote control box 115, and power supply 106.

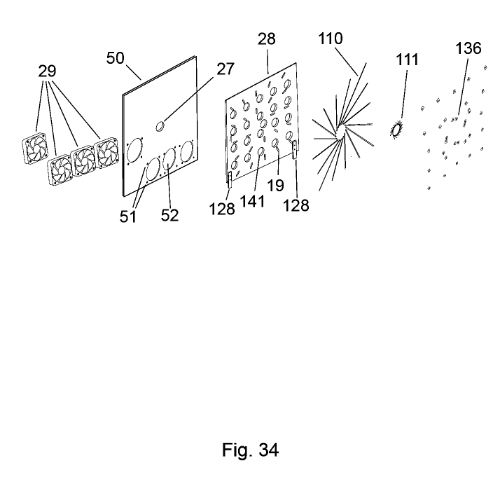

FIG. 34 is an exploded view of one embodiment of the radial arms and their assembly. FIG. 34 shows the radial arms 110 with a connecting rod hole 19, control knob shaft hole 27, control mechanism mounting plate 28, cooling fans 29, fan mounting plate 50, fan mounting plate holes 51, fan outlet 52, radial fingers 111, spacer/mounting foot 128, fluoropolymer bracket 136, and ventilation holes 141.

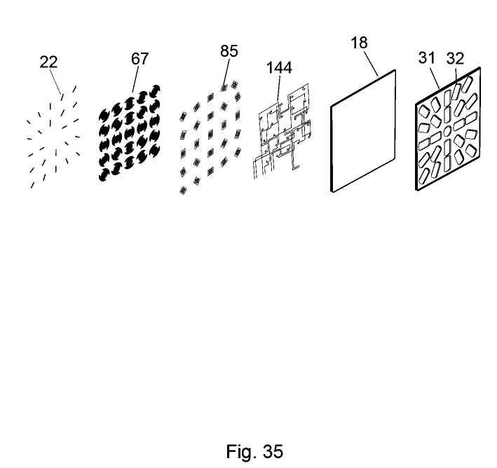

FIG. 35 is an exploded view of one embodiment of the heat sinks, fans and their assembly. FIG. 35 shows the heat sink assembly with clear plastic cover 18, connecting rod 22, cover plate 31, cover plate holes 32, heat sink 67, LED 85, and wiring loom 144.

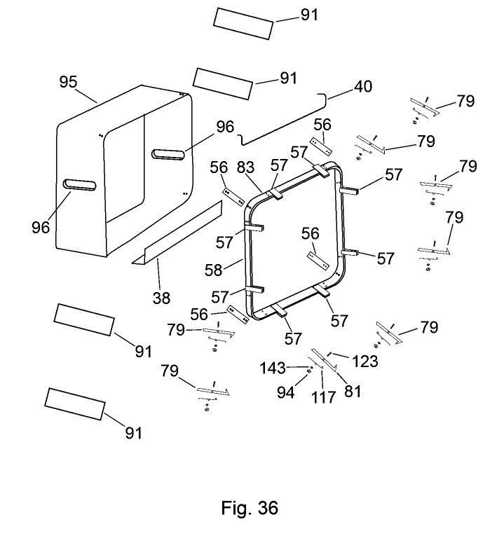

FIG. 36 is an exploded view of one embodiment of the outer case. FIG. 36 shows the outer case 95 with diffusion holder bottom rail 38, diffusion holder top piece 40, flap mount bracket attachments 56, flap retaining bracket 57, flap retaining bracket assembly 58, latch assembly 79, latch mounting holes 83, latch hook 81, male hook and eye tab 91, nut 94, outer case expanding slot 96, return spring 117, screw 123, and washer 143.

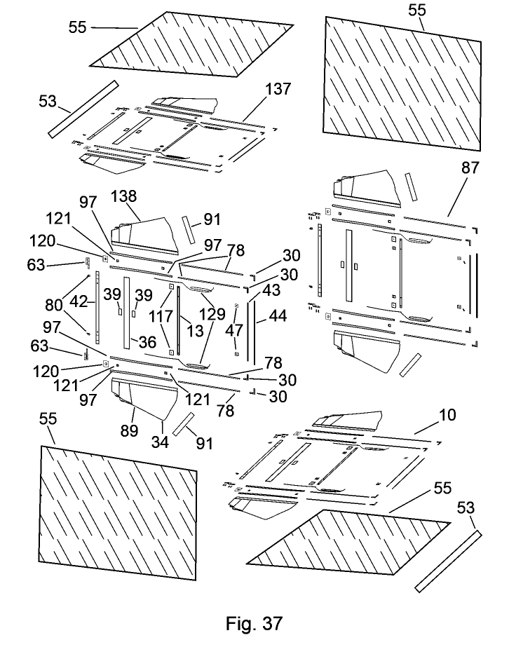

FIG. 37 is an exploded view of one embodiment of the flaps. FIG. 37 shows the flaps with bottom flap assembly 10, center support brace 13, corner connector 30, curtain seem 34, female hook and eye strip 53, flap cover 55, end brace 42, diffusion holder pull tab 39, diffusion door 36, end rod inner 43, end rod outer 44, end rods bracket 47, friction hinge 63, inner extending rod 78, latch catch 80, left flap assembly 87, lower curtain 89, return spring 117, rod restraint 120, rod separator 121, spring 129, top flap assembly 137, and upper curtain 138.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

What is claimed is:

1. A LED fixture comprising:
a rear control unit;
an expandable light box;
an one or more high-powered LEDs;
an one or more ventilation fans;
a diffusion track;
an one or more adjustable light-controlling flaps; and
an one or more noise baffles;
wherein said one or more high-powered LEDs are grouped into an one or more LED clusters;
wherein said expandable light box comprises an adjustable outer case and an adjustable inner case,
wherein said rear control unit comprises an adjuster, an one or more circuit switches, a master switch, a turbo switch, a dimmer lever, and a fan exhaust; and
wherein said adjuster alters an one or more directions of a light from said one or more LED clusters.

2. The LED fixture of claim 1, further comprising:
an one or more heat sinks;
wherein said heat sinks are fan-shaped and
wherein said one or more LED clusters are mounted on said one or more heat sinks.

3. The LED fixture of claim 2, wherein said adjuster comprises a knob, an one or more radial arms, an one or more fingers, an one or more connecting rods, and a shaft;
wherein said knob is connected to said shaft, said shaft is further connected to said one or more radial arms, said radial arms are further connected to said one or more fingers, said one or more fingers are further connected to said one or more connecting rods, said one or more connecting rods are connected to said one or more LED clusters; and
wherein said knob, when turned, causes said one or more LED clusters to swivel so that said one or more LED clusters move simultaneously to focus or defuse said light.

4. The LED fixture of claim 3, further comprising:
an one or more circuits;
wherein said one or more circuits are controlled by said one or more circuit switches;
wherein said one or more LED clusters are grouped into an one or more circuit cluster groups;
wherein said one or more circuit cluster groups are connected to said an one or more circuits; and
wherein said one or more circuits provide power to said one or more circuit cluster groups independently or simultaneously.

5. The LED fixture of claim 4, wherein said turbo switch eliminates an one or more LED cluster from said one or more circuit cluster group to increase the brightness of the remaining said one or more LED clusters.

6. The LED fixture of claim 5, further comprising:
a remote control;
wherein said remote control controls said adjuster, said dimmer lever, said turbo switch, said master switch, and said circuit switches.

7. The LED fixture of claim 6, wherein said remote control is connected, via hard wire, to said rear of said adjustable inner case.

8. The LED fixture of claim 7, wherein said adjustable outer case houses said diffusion track and said one or more adjustable light-controlling flaps; and
wherein said adjustable inner case houses said rear control unit; said one or more LED clusters; said one or more ventilation fans; said one or more noise baffles; and said one or more heat sinks.

9. The LED fixture of claim 8, further comprising:
a diffuser;
wherein said adjustable outer case telescopes away from a rear of said adjustable inner case to move said diffuser distally away from said LED clusters and alter said light.

10. The LED fixture of claim 9, wherein said rear control unit further comprises an indicator light; and
wherein said indicator light, said one or more circuit switches, said turbo switch, said master switch, said dimmer lever, and said knob are recessed on an outside of said rear of said adjustable inner case.

11. The LED fixture of claim 10, wherein said adjustable inner case further comprises a power supply housing.

12. The LED fixture of claim 11, wherein said diffusion track has two or more openings for insertion of a diffuser or color correction.

13. The LED fixture of claim 12, wherein said adjustable light-controlling flaps have an open position and a closed position.

14. The LED fixture of claim 13, wherein said adjustable light-controlling flaps are extendable.

15. The LED fixture of claim 14, further comprising:
an one or more curtains;
wherein said curtains are attached to said adjustable light-controlling flaps to reduce light leakage.

16. The LED fixture of claim 15, wherein said clusters of high-powered LEDs are arranged in a honeycomb pattern.

17. The LED fixture of claim 16, wherein said expandable light box tilts up and down.

18. The LED fixture of claim 17, wherein said noise baffles minimize noise produced by said ventilation fans.

19. A LED fixture comprising:
a rear control unit;
an expandable light box;
an one or more high-powered LEDs;
an one or more ventilation fans;
a diffusion track;
an one or more adjustable light-controlling flaps;
an one or more noise baffles;
an one or more heat sinks;
an one or more circuits;
a remote control;
a diffuser; and
an one or more curtains;
wherein said one or more high-powered LEDs are grouped into an one or more LED clusters;
wherein said expandable light box comprises an adjustable outer case and an adjustable inner case;
wherein said rear control unit comprises an adjuster, an one or more circuit switches, a master switch, a turbo switch, a dimmer lever, and a fan exhaust;
wherein said adjuster alters an one or more directions of a light from said one or more LED clusters;
wherein said heat sinks are fan-shaped;
wherein said one or more LED clusters are mounted on said one or more heat sinks;
wherein said adjuster comprises a knob, an one or more radial arms, an one or more fingers, an one or more connecting rods, and a shaft;
wherein said knob is connected to said shaft, said shaft is further connected to said one or more radial arms, said radial arms are further connected to said one or more fingers, said one or more fingers are further connected to said one or more connecting rods, said one or more connecting rods are connected to said one or more LED clusters;
wherein said knob, when turned, causes said one or more LED clusters to swivel so that said one or more LED clusters move simultaneously to focus or defuse said light;
wherein said one or more circuits are controlled by said one or more circuit switches;
wherein said one or more LED clusters are grouped into an one or more circuit cluster groups;
wherein said one or more circuit cluster groups are connected to said an one or more circuits;
wherein said one or more circuits provide power to said one or more circuit cluster groups independently or simultaneously;
wherein said remote control controls said adjuster, said dimmer lever, said turbo switch, said master switch, and said circuit switches;
wherein said turbo switch eliminates an one or more LED cluster from said one or more circuit cluster group to increase the brightness of the remaining said one or more LED clusters;
wherein said remote control is connected, via hard wire, to said rear of said adjustable inner case;
wherein said adjustable outer case houses said diffusion track and said one or more adjustable light-controlling flaps;
wherein said adjustable inner case houses said rear control unit; said one or more LED clusters; said one or more ventilation fans; said one or more noise baffles; and said one or more heat sinks;
wherein said adjustable outer case telescopes away from a rear of said adjustable inner case to move said diffuser distally away from said LED clusters and alter said light;
wherein said rear control unit further comprises an indicator light;
wherein said indicator light, said one or more circuit switches, said turbo switch, said master switch, said dimmer lever, and said knob are recessed on an outside of said rear of said adjustable inner case;
wherein said adjustable inner case further comprises a power supply housing;
wherein said diffusion track has two or more openings for insertion of a diffuser or color correction;
wherein said adjustable light-controlling flaps have an open position and a closed position;
wherein said adjustable light-controlling flaps are extendable;
wherein said curtains are attached to said adjustable light-controlling flaps to reduce light leakage;
wherein said clusters of high-powered LEDs are arranged in a honeycomb pattern;
wherein said expandable light box tilts up and down; and
wherein said noise baffles minimize noise produced by said ventilation fans.
